(19) United States
(12) Patent Application Publication
(10) Pub. No.: US 2011/0250800 A1
(43) Pub. Date: Oct. 13, 2011

(54) BOARD TO BOARD CONNECTOR ASSEMBLY HAVING IMPROVED PLUG AND RECEPTACLE CONTACTS

(75) Inventor: Jing-Jie Guo, Shenzhen (CN)

(73) Assignee: HON HAI PRECISION INDUSTRY CO., LTD., New Taipei (TW)

(21) Appl. No.: 13/084,597

(22) Filed: Apr. 12, 2011

(30) Foreign Application Priority Data
Apr. 12, 2010 (CN) 201020155816.9
Apr. 12, 2010 (CN) 201020156119.5

(51) Int. Cl. H01R 24/00

(52) U.S. Cl. 439/660

(57) ABSTRACT

A board to board connector assembly (100) includes a plug connector (10) and a receptacle connector (20) for receiving the plug connector along a mating direction. The plug connector includes a plug insulative housing (11) and a number of plug contacts (12) received in the plug insulative housing. The receptacle connector includes a receptacle insulative housing (21) and a number of receptacle contacts (23) received in the receptacle insulative housing. Each of the plug contact and the receptacle contact includes a main portion (121, 121′, 231, 231′), a soldering pad (120, 120′, 230, 230′), a retention beam (122, 122′, 232, 232′), and a contacting beam (123, 123′, 233, 233′). The contacting beam of the plug contact has an inclined face (124, 124′) and a securing portion (125, 125′) protruding toward the retention beam. The contacting beam of the receptacle contact has a tail portion (235, 235′) angularly extending towards the retention beam. The plug contact inclined face initially guidingly engages with the receptacle contact tail portion and finally the receptacle contact tail portion is positioned between the securing portion and the main portion of the plug contact when the plug and receptacle connectors are mated to each other.

### BACKGROUND OF THE INVENTION

1. Field of the Invention

The present invention relates generally to a board to board connector assembly, and more particularly to a low profile board to board connector assembly.

2. Description of Related Arts

U.S. Pat. No. 6,540,561 issued to Masumoto on Apr. 1, 2003 discloses a board to board connector assembly comprising a receptacle connector and a plug connector engaged with the receptacle connector along a first direction for electrical connection therebetween. Each of the receptacle connector and the plug connector includes a plurality of contacts. The receptacle contact includes a contact portion which forms a protrusion protruding along a second direction perpendicular to the first direction. The plug contact includes a mating portion with a concave portion recessed along the second direction. Therefore, the plug contact and the receptacle contact are securely engaged with each other when the protrusion is received in the concave portion. The specific shape, profile, and/or cross-section of either the plug or receptacle contact makes it difficult to reduce its height.

Hence, a board to board connector assembly having different plug and receptacle contacts design is desired to overcome the aforementioned disadvantage of the prior art.

### SUMMARY OF THE INVENTION

Accordingly, an object of the present invention is to provide a low profile board to board connector assembly having different plug and receptacle contacts design.

To achieve the above object, a board to board connector assembly includes a plug connector and a receptacle connector for receiving the plug connector along a mating direction. The plug connector includes a plug insulative housing and a number of plug contacts received in the plug insulative housing. The receptacle connector includes a receptacle insulative housing and a number of receptacle contacts received in the receptacle insulative housing. Each of the plug contact and the receptacle contact includes a main portion, a soldering pad, a retention beam, and a contacting beam. The contacting beam of the plug contact has an inclined face and a securing portion protruding toward the retention beam. The contacting beam of the receptacle contact has a tail portion angularly extending towards the retention beam. The plug contact inclined face initially guidingly engages with the receptacle contact tail portion and finally the receptacle contact tail portion is positioned between the securing portion and the main portion of the plug contact when the plug and receptacle connectors are mated to each other.

Other objects, advantages and novel features of the invention will become more apparent from the following detailed description when taken in conjunction with the accompanying drawings.

### BRIEF DESCRIPTION OF THE DRAWINGS

FIG. 1 is a perspective, assembled view of a board to board connector assembly constructed in accordance with the present invention;

FIG. 2 is a perspective, exploded view of the board to board connector with respect to FIG. 1;

FIG. 3 is a perspective, further exploded view of a plug connector;

FIG. 4 is a perspective, further exploded view of a receptacle connector;

FIG. 5 is a partly cross-sectional view of the board to board connector assembly taken along line IV-IV of FIG. 1;

FIG. 6 is a perspective, exploded view of two groups of the plug contacts and the corresponding receptacle contacts;

FIG. 7 is a perspective, assembled view of two groups of the plug contacts and the corresponding receptacle contacts;

FIG. 8 is similar to FIG. 6, but taken another aspect; and

FIG. 9 is similar to FIG. 7, but taken another aspect.

### DETAILED DESCRIPTION OF THE PREFERRED EMBODIMENT

Reference will now be made in detail to the preferred embodiment of the present invention.

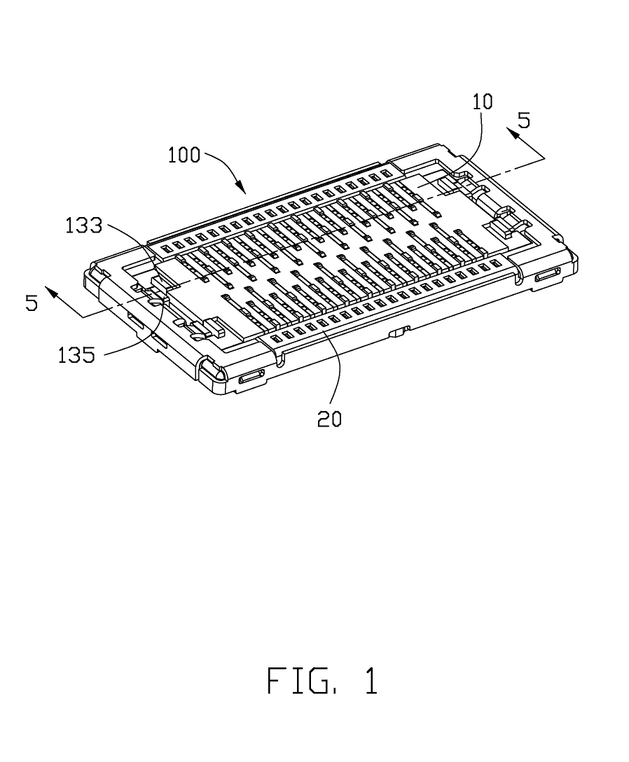

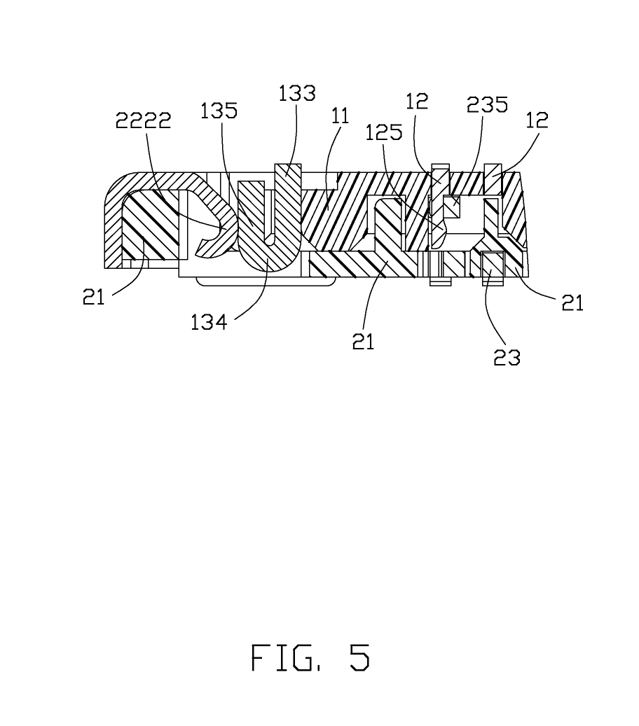

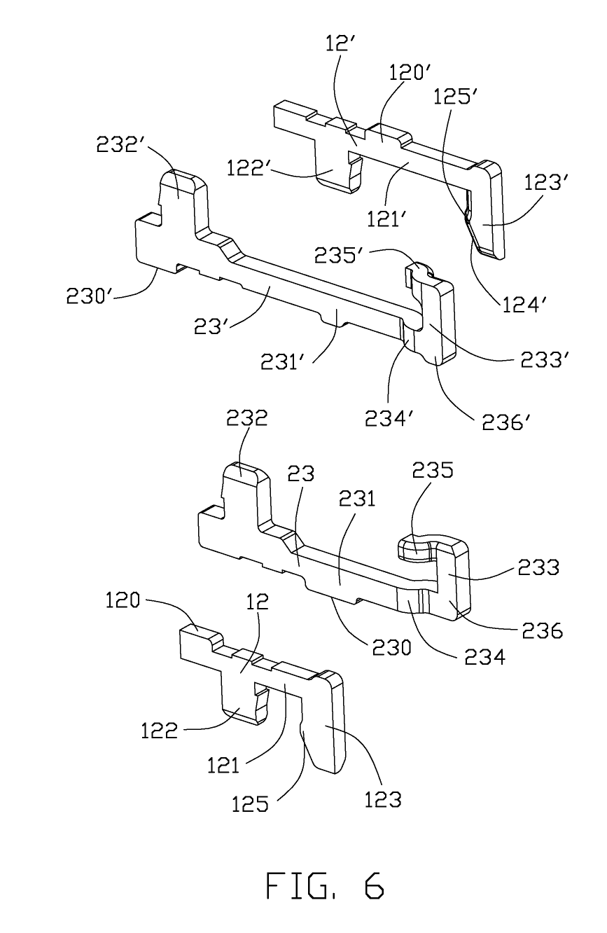

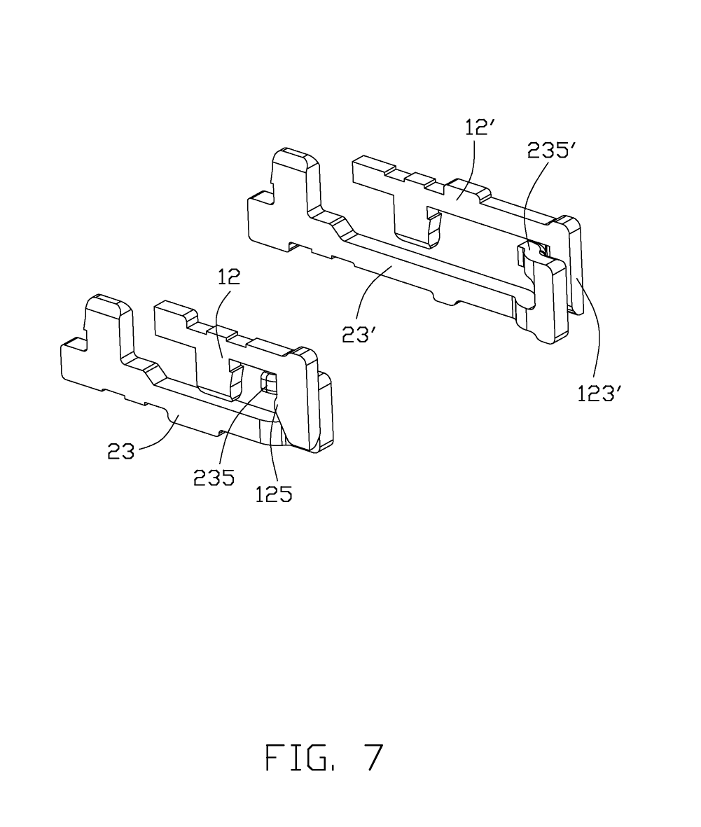

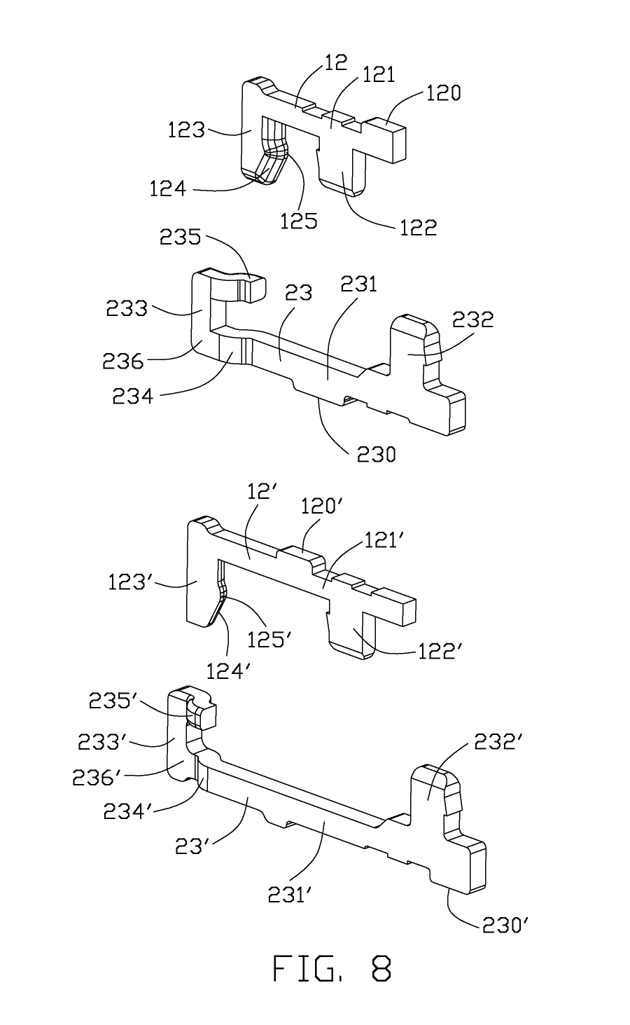

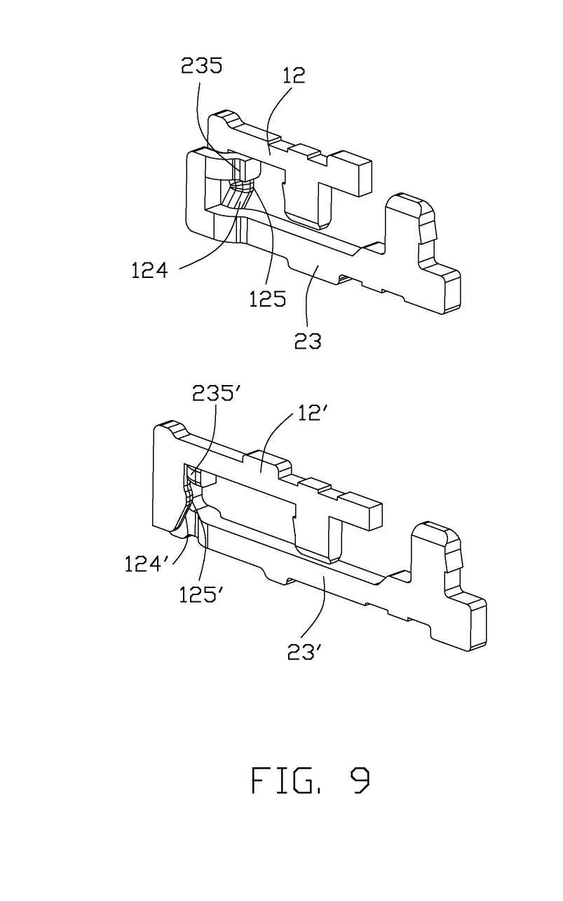

Referring to FIGS. 1-9, a board to board connector assembly 100 in accordance with the present invention comprises a plug connector 10 and a receptacle connector 20 receiving the plug connector 10 along a vertical direction.

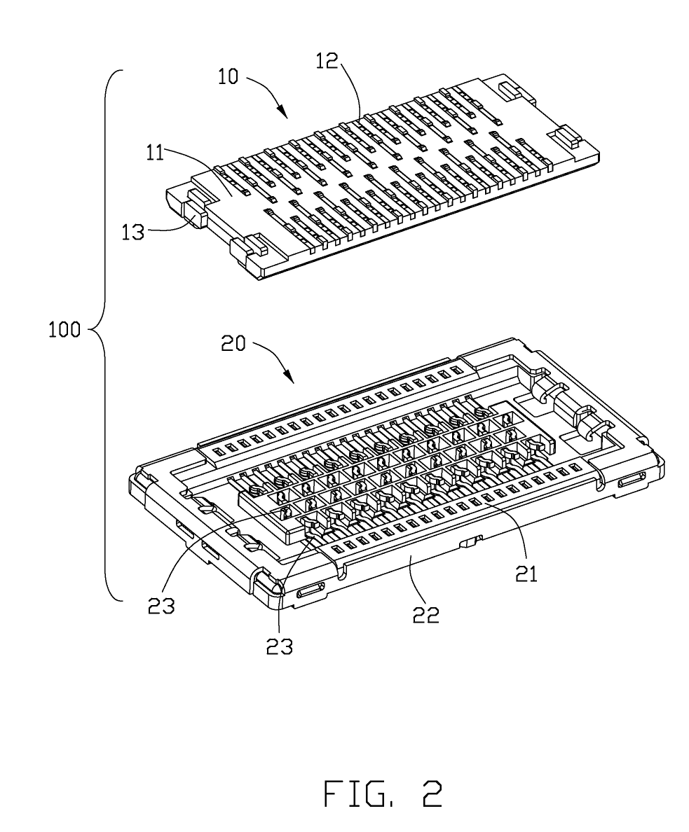

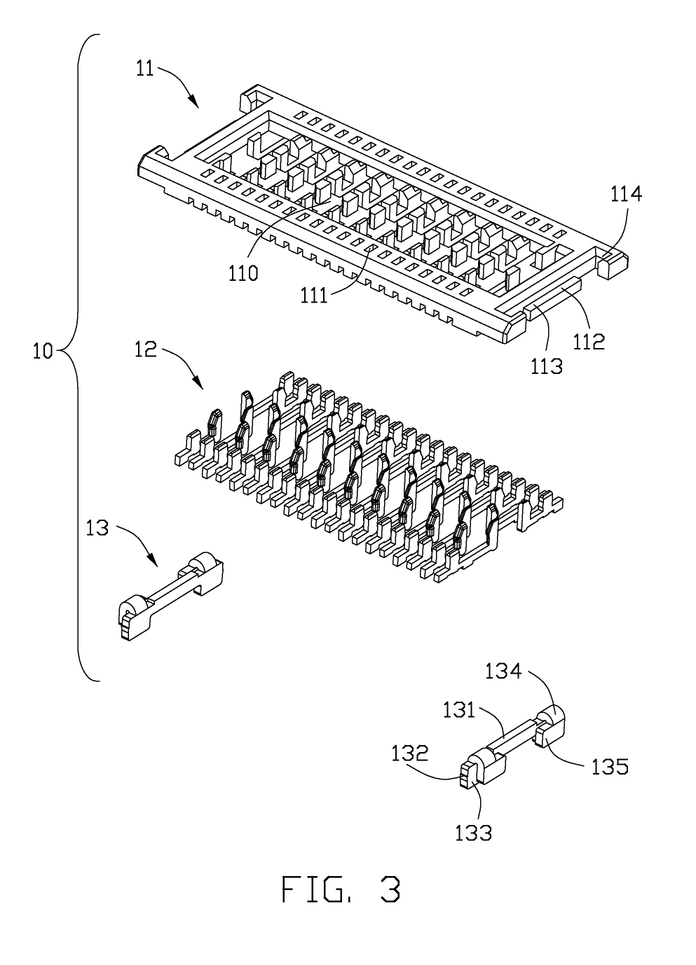

Referring to FIGS. 2 and 3, the plug connector 10 comprises a plug insulative housing 11 extending along a transverse direction perpendicular to the vertical direction, a plurality of plug contacts 12 received in the plug insulative housing 11, and a pair of metal plates 13 assembled at two opposite ends of the plug insulative housing 11. The plug insulative housing 11 defines a recess 110 in the middle part thereof and a plurality of plug passageways 111 beside two sides of the recess 110. The plug contacts 12 are received in the plug passageways 111 and partly extend out of the recess 110. The plug insulative housing 11 defines a pair of fixing portions 112 at two opposite ends thereof. Each fixing portion 112 forms a block portion 113 in the middle thereof and a pair of curved portions 114 at two opposite sides of the block portion 113. The metal plate 13 comprises a main beam 131, a pair of arc portions 134 curvedly upwardly extending from two ends of the main beam 131, and a pair of confronting portions 135 each extending downwardly from the corresponding arc portions 134 respectively. The confronting portions 135 space away from the main beam 131. The metal plate 13 further comprises a pair of soldering portions 133 at two opposite ends of the main beam 131. The soldering portions 133 are used for soldering with a printed circuit board. Each soldering portion 133 forms a plurality of ribs 132 at out edges thereof. The ribs 132 are securely engaged with the arc portions 134 and therefore, the metal plates 13 are securely assembled on the plug insulative housing 11.

Referring to FIGS. 3, 6-9, the plug contact 12 comprises a main portion 121, a soldering pad 120 protruding from an upper edge of the main portion 121, a retention beam 122 extending from an opposite lower edge of the main portion 121, and a contacting beam 123 extending from the lower edge of the main portion 121. The contacting beam 123 has a length larger than that of the retention beam 122, and therefore, when the plug contact 12 is retained in the plug insulative housing 11, the retention beam 122 is received in the plug passageway 111 for retention purpose while the contacting beam 123 extends out of the recess 110 for engagement purpose. The plug contacts 12 are formed into two groups with differences only at: each of the first plug contacts 12 has a shorter main portion 121 and the retention portion 122 is positioned between the soldering pad 120 and the contacting beam 123 along a lengthwise direction perpendicular to both the vertical direction and the transverse direction; each of the second plug contacts 12′ has a larger main portion 121′ and the soldering pad 120′ is positioned between the retention portion 122′ and the contacting beam 123′. Therefore, the contacting beams 123, 123′ space away from the corresponding retention beams 122, 122′ for different distances. When the plug contacts 12, 12′ are assembled in the plug insulative housing 11, the retention portions 122, 122′ are retained in the plug passageways 111 to be arranged in two parallel lines along the transverse direction. The soldering pads 120, 120′ are arranged in four different parallel lines along the transverse direction. The contacting beams 123, 123′ are also arranged another four different parallel lines along the transverse direction. Each contacting beam 123, 123′ comprises an inclined rounded or smooth face 124, 124′ for guiding purpose and a securing portion 125, 125′ protruding towards the retention portion 122, 122′ for engagement purpose.

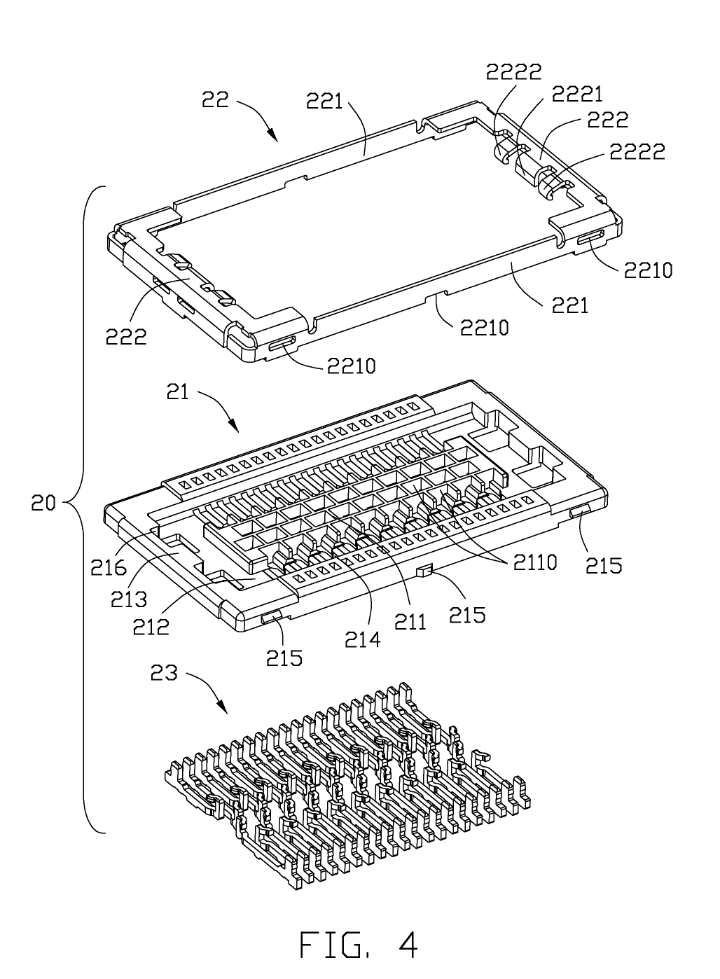

Referring to FIGS. 2 and 4, the receptacle connector 20 comprises a receptacle insulative housing 21, a plurality of receptacle contacts 22 received in the receptacle insulative housing 21, and a metallic shell 23 covering the receptacle insulative housing 21. The receptacle insulative housing 21 has a dimension larger than that of the plug insulative housing 11. The receptacle insulative housing 21 defines a concaved channel 212 essentially receiving the plug insulative housing 11. The receptacle insulative housing 21 comprises a protuberance portion 211 extending upward from the concaved channel 211 and the protuberance portion 211 is received in the recess 110 of the plug insulative housing 11 for engagement. The protuberance portion 211 defines a plurality of block units 2110. The receptacle insulative housing 21 defines a plurality of receptacle passageways 214 beside two sides of the concaved channel 212 respectively. The receptacle contacts 22 are retained in the receptacle passageways 214 for retention purpose and partly extend into the block units 2110 for engagement purpose. The receptacle insulative housing 21 forms a pair of heaves 213 protruding towards the concaved channel 212 and defines a pair of cutouts 216 at opposite sides of the heaves 213. The receptacle insulative housing 21 further forms a plurality of protrusions 215.

Referring to FIGS. 4, 6-9, the receptacle contact 23 comprises a main portion 231, a soldering pad 230 at a lower edge of the main portion 231, a retention beam 232 and a contacting beam 233 both at an upper edge of the main portion 231. The contacting beam 233 has a height similar to that of the retention beam 232, and therefore, when the receptacle contact 23 is retained in the receptacle insulative housing 21, the retention beam 232 is received in the receptacle passageway 214 for retention purpose while the contacting beam 233 is also received in the block unit 2110 for engagement purpose. The receptacle contacts 23 are also formed into two groups, similar to the plug contacts 12, but that: each of the first group of receptacle contacts 23 has a shorter main portion 231 and the soldering pad 230 is positioned between the retention beam 232 and the contacting beam 233 along the lengthwise direction; and each of the second group of receptacle contacts 23′ has a larger main portion 231′ and the retention beam 232′ is positioned between the soldering pad 230′ and the contacting beam 233′. Therefore, when the receptacle contacts 23, 23′ are assembled in the receptacle insulative housing 21, the retention beams 232, 232′ are retained in the receptacle passageways 214 to be arranged in two parallel lines along the transverse direction. The soldering pads 230, 230′ are arranged in four different parallel lines along the transverse direction. The contacting beams 233, 233′ are also arranged in another four different parallel lines along the transverse direction. Different from the plug contacts 12, each contacting beam 233, 233′ comprises a curved portion 234, 234′ connecting to the main portion 231, 231′, a vertical portion 236, 236′ extending upwardly from the curved portion 234, 234′, and a tail portion 235, 235′ angularly returning back towards the retention beam 232, 232′. The tail portions 235, 235′ space away from the retention beams 232, 232′ for different distances due to different lengths of the main portions 231, 231′. With such a receptacle contacting beam, a better elastic or spring property, force response, torque, etc., during engagement with the plug contacting beam, is expected.

Referring to FIG. 4, the metallic shell 22 is frame-shaped and comprises a pair of lengthwise beams 221 and a pair of transverse beams 222 connecting to different ends of the lengthwise beams 221 for defining an interspace therebetween (not labeled). Each lengthwise beam 221 defines a plurality of slits 2210 receiving the protrusions 215 and therefore, the metallic shell 22 is securely assembled on the receptacle insulative housing 21 thereby. Each transverse beam 222 forms a wrapped portion 2221 at the middle thereof and a pair of flexible beams 2222 at two sides of the wrapped portion 2221. Both the wrapped portions 2221 and the flexible beams 2222 extend into the interspace.

Referring to FIGS. 2-4, when the metallic shell 22 is assembled on the receptacle insulative housing 21, the wrapped portions 2221 covers the corresponding heaves 213 for additionally securing the metallic shell 22 on the receptacle insulative housing 21. The flexible beams 2222 are correspondingly received in the cutouts 216. When the plug connector 10 is assembled into the receptacle connector 20, the confronting portions 135 of the metal plates 13 interfere with the flexible beams 2222 along the transverse direction and therefore, the plug connector 10 is securely received in the receptacle connector 20. Because each metal plate 13 forms a pair of confronting portions 135 and each transverse beam 222 forms a pair of flexible beams 2222, the interference force therebetween is reinforced.

When the plug connector 10 is assembled into the receptacle connector 20, the plug contacts 12, 12′ are firstly guided by the inclined faces 124, 124′, and then the securing portions 125, 125′ of the plug contacts 12, 12′ go across the tail portions 235, 235′ of the receptacle contacts 23, 23′. Finally, the tail portions 235, 235′ of the receptacle contacts 23, 23′ are positioned between the securing portions 125, 125′ and the main portions 121, 121′ of the plug contacts 12, 12′. A user feels a clicking therefrom, which indicates to the user that the plug contacts 12, 12′ have finally been engaged with the corresponding receptacle contacts 23, 23′ already. Because the unique configuration of the plug contacts 12, 12′ and the receptacle contacts 23, 23′, the plug connector 10 and the receptacle connector 20 are reliably engaged with each other.

While a preferred embodiment in accordance with the present invention has been shown and described, equivalent modifications and changes known to persons skilled in the art according to the spirit of the present invention are considered within the scope of the present invention as described in the appended claims.

What is claimed is:

1. A board to board connector assembly comprising:
a plug connector comprising:
a plug insulative housing and a plurality of plug contacts received in the plug insulative housing, each plug contact including a main portion, a soldering pad, a retention beam, and a contacting beam, the contacting beam of the plug contact having an inclined face and a securing portion protruding toward the retention beam; and
a receptacle connector for receiving the plug connector along a mating direction comprising:
a receptacle insulative housing and a plurality of receptacle contacts received in the receptacle insulative housing, each receptacle contact including a main portion, a soldering pad, a retention beam, and a contacting beam, the contacting beam of the receptacle contact having a tail portion angularly extending towards the retention beam; wherein
the plug contact inclined face initially guidingly engages with the receptacle contact tail portion and finally the receptacle contact tail portion is positioned between the securing portion and the main portion of the plug contact when the plug and receptacle connectors are mated to each other.

2. The board to board connector assembly as claimed in claim 1, wherein the retention beams of the plug contacts and the receptacle contacts are respectively arranged in two lines, the contacting beams thereof are arranged in four lines, and the soldering pads are arranged in another four lines.

3. The board to board connector assembly as claimed in claim 1, wherein the main portions of the plug contacts and the receptacle contacts are respectively provided with two different lengths.

4. The board to board connector assembly as claimed in claim 3, wherein the retention beam of a shorter plug contact is positioned between associated soldering pad and contacting beam along a lengthwise direction of the main portion.

5. The board to board connector assembly as claimed in claim 4, wherein the soldering pad of a longer plug contact is positioned between associated retention beam and contacting beam along the lengthwise direction.

6. The board to board connector assembly as claimed in claim 3, wherein the soldering pad of a shorter receptacle contact is positioned between associated retention beam and contacting beam along a lengthwise direction of the main portion.

7. The board to board connector assembly as claimed in claim 6, wherein the retention beam of a longer receptacle contact is positioned between associated soldering pad and contacting beam along the lengthwise direction.

8. The board to board connector assembly as claimed in claim 1, wherein the soldering pad is formed at an opposite side of the main portion with respect to the retention portion and the contacting portion.

9. The board to board connector assembly as claimed in claim 1, wherein the plug connector comprises a pair of metal plates assembled at two opposite ends of the plug insulative housing and the receptacle connector comprises a metallic shell covering the receptacle insulative housing, and the metal plates interfere with the metallic shell along a transverse direction.

10. The board to board connector assembly as claimed in claim 9, wherein each metal plate comprises a pair of confronting portions and the metallic shell forms a plurality of flexible beams correspondingly interfering with the confronting portions.

11. A board to board connector assembly comprising:
a first connector including:
a first insulative housing defining a plurality of first passageways along a longitudinal direction;
a plurality of first contacts disposed in the corresponding passageways, respectively, each of said first contacts including a first main portion, a first retention portion and a first contacting section and essentially commonly lying in a first plane; and
a second connector mateable with the first connector and including:
a second insulative housing defining a plurality of second passageways along said longitudinal direction;
a plurality of second contacts disposed in the corresponding passageways, respectively, each of said second contacts including a second main portion, a second retention portion and a second contacting section and essentially commonly lying in a second plane except a contacting beam of the second contact section which extends away from said another plane in a resilient manner; wherein
when the first connector and the second connector are mated with each other, the first contact in the first plane is intimately located beside the corresponding second contact in the second plane in said longitudinal direction under condition that the second contacting section extends from the second plane to reach the first plane and contact the first contacting section.

12. The board to board connector assembly as claimed in claim 11, wherein the first contacts and the second contacts are not of the same dimension in a transverse direction perpendicular to said longitudinal direction.

13. The board to board connector assembly as claimed in claim 12, wherein said second contacts are longer than the first contacts in said transverse direction.

14. The board to board connector assembly as claimed in claim 11, wherein the first contacts include longer ones and shorter ones dimensioned in a transverse direction perpendicular to the longitudinal direction, and alternately arranged with each other in a staggered manner along the longitudinal direction; the second contacts include longer ones and shorter ones dimensioned in said transverse direction, and alternately arranged with each other in said staggered manner along the longitudinal direction.

15. The board to board connector assembly as claimed in claim 14, wherein the staggeringly arranged longer ones and shorter ones of the first contacts are disposed on both lateral sides of the first housing in the transverse direction in a zigzag manner; the staggeringly arranged longer ones and shorter ones of the second contacts are disposed on both lateral sides of the second housing in the transverse direction in the zigzag manner.

16. The board to board connector assembly as claimed in claim 11, wherein the first contacting section and the second contacting section are aligned with each other in the longitudinal direction.

17. The board to board connector assembly as claimed in claim 11, wherein the contacting beam of the second contacting section extends horizontally in a transverse direction perpendicular to said longitudinal direction.

18. A board to board connector assembly comprising:
a first connector comprising:
a first insulative housing defining a plurality of first passageways along a longitudinal direction;
a plurality of first contacts disposed in the corresponding first passageways, respectively, each of said first contacts primarily lying in a first plane;
a second connector comprising:
a second insulative housing defining a plurality of second passageways along the longitudinal direction;
a plurality of second contacts disposed in the corresponding second passageways, respectively, each of said second contacts primarily lying in a second plane; wherein
the first contacts include longer ones and shorter ones dimensioned in a transverse direction perpendicular to the longitudinal direction, and alternately arranged with each other in a staggered manner along the longitudinal direction; the second contacts include longer ones and shorter ones dimensioned in said transverse direction, and alternately arranged with each other in said staggered manner along the longitudinal direction; wherein
the staggeringly arranged longer ones and shorter ones of the first contacts are disposed on both lateral sides of the first housing in the transverse direction in a zigzag manner; the staggeringly arranged longer ones and shorter ones of the second contacts are disposed on both lateral sides of the second housing in the transverse direction in the zigzag manner.

19. The board to board connector assembly as claimed in claim 18, wherein the first passageways include longer ones and shorter ones dimension in the transverse direction and alternately arranged with each other in the staggered manner along the longitudinal direction; the second passageways include longer ones and shorter ones dimension in the transverse direction and alternately arranged with each other in the staggered manner along the longitudinal direction; wherein the staggeringly arranged longer ones and shorter ones of the first passageways are disposed on both the lateral sides of the first housing in the transverse direction in the zigzag manner; the staggeringly arranged longer ones and shorter ones of the second passageways are disposed on both the lateral sides of the second housing in the transverse direction in the zigzag manner

20. The board to board connector assembly as claimed in claim 19, wheren when the first connector and the second connector are mated with each other, the first contact in the first plane is intimated located beside the corresponding second contact in the second plane in the longitudinal direction.
